(19) United States
(12) Patent Application Publication
(10) Pub. No.: US 2020/0211829 A1
(43) Pub. Date: Jul. 2, 2020

(54) IMAGING MASS SPECTROMETRY DEVICE, MASS SPECTROMETRIC METHOD, AND COMPUTER PROGRAM PRODUCT

(71) Applicant: SHIMADZU CORPORATION, Kyoto-shi (JP)

(72) Inventors: Eiichi MATSUO, Kyoto-shi (JP); Takushi Yamamoto, Kyoto-shi (JP)

(73) Assignee: SHIMADZU CORPORATION, Kyoto-shi (JP)

(21) Appl. No.: 16/661,072

(22) Filed: Oct. 23, 2019

(30) Foreign Application Priority Data
Dec. 26, 2018 (JP) 2018-242540

(51) Int. Cl. H01J 49/00; H01J 49/14

(52) U.S. Cl. CPC H01J 49/0004; H01J 49/004; H01J 49/14

(57) ABSTRACT

An imaging mass spectrometry device includes: an ionization unit that ionizes a sample at a plurality of positions on the sample; a mass spectrometry unit that performs mass spectrometry on the ionized sample and detects fragment ions generated by dissociation of a precursor ion derived from the sample; a data acquisition unit that acquires intensity data in which intensities of a fragment ion are correlated with the plurality of positions on the sample; an image creation unit that creates image data in which a value obtained by integrating the intensity data corresponding to a plurality of different fragment ions generated from the same precursor ion is expressed by a pixel value or a pixel color at positions on an image respectively corresponding to the plurality of positions; and a display unit that displays an image corresponding to the image data.

### INCORPORATION BY REFERENCE

The disclosure of the following priority application is herein incorporated by reference: Japanese Patent Application No. 2018-242540 filed Dec. 26, 2018

### TECHNICAL FIELD

The present invention relates to an imaging mass spectrometry device, a mass spectrometric method, and a computer program product.

### BACKGROUND ART

Mass spectrometric imaging is a method of performing mass spectrometry on components at a plurality of positions on a sample to acquire a distribution of a molecule having a predetermined mass in the sample. In a case where a tissue section or the like obtained from an organism is used as a sample, it can be observed how a molecule of interest is localized in the organism without labeling the molecule with a radioactive isotope or the like. The mass spectrometric imaging can thus be used for various analyses utilizing positional information on molecules (see NPTL1).

In a mass spectrometric imaging based on a MS/MS measurement, an image showing a mass distribution for each fragment ion is generated. Thereby, positional information on a molecule of interest can be visually recognized (see PTL1).

### CITATION LIST

### Patent Literature

PTL1: Japanese Laid-Open Patent Publication No. 2014-206389

### Non-Patent Literature

NPTL1: Pierre Chaurand, Sarah A. Schwartz, Richard M. Caprioli. “Profiling and Imaging Proteins in Tissue Sections by MS” Analytical Chemistry, (USA), ACS Publications, Mar. 1, 2004, Volume 76, Issue 5, pp. 86A-93A

### SUMMARY OF INVENTION

### Technical Problem

The present invention provides an imaging mass spectrometry device capable of clearly visualizing a distribution of a molecule corresponding to a plurality of detected fragment ions.

### Solution to Problem

According to a first aspect of the present invention, an imaging mass spectrometry device, comprises: an ionization unit that ionizes a sample at a plurality of positions on the sample; a mass spectrometry unit that performs mass spectrometry on the ionized sample and detects fragment ions generated by dissociation of a precursor ion derived from the sample; a data acquisition unit that acquires intensity data in which intensities of a fragment ion are correlated with the plurality of positions on the sample; an image creation unit that creates image data in which a value obtained by integrating the intensity data corresponding to a plurality of different fragment ions generated from the same precursor ion is expressed by a pixel value or a pixel color at positions on an image respectively corresponding to the plurality of positions; and a display unit that displays an image corresponding to the image data.

According to a second aspect of the present invention, in the imaging mass spectrometry device according to the first aspect, it is preferable that the image creation unit creates the image data corresponding to the image in which the values corresponding to the same precursor ion are displayed with colors wherein at least one of hue, saturation, and brightness of the colors are the same.

According to a third aspect of the present invention, in the imaging mass spectrometry device according to the first or second aspect, it is preferable that the display unit displays a first screen component for switching to a screen that displays the image from a screen that displays intensities corresponding to the plurality of different fragment ions generated from the same precursor ion separately between the fragment ions.

According to a fourth aspect of the present invention, in the imaging mass spectrometry device according to any one of the first to third aspects, it is preferable that the image creation unit calculates pixel values at positions on an image corresponding to the plurality of positions based on the intensity data of the plurality of different fragment ions generated from the same precursor ion and a correction parameter, to create the image data.

According to a fifth aspect of the present invention, in the imaging mass spectrometry device according to the fourth aspect, it is preferable that the display unit displays a second screen component for changing the correction parameter.

According to a sixth aspect of the present invention, in the imaging mass spectrometry device according to the fourth aspect, it is preferable that the correction parameter is determined based on a ratio of intensities of the plurality of fragment ions set in advance based on data obtained in a past measurement.

According to a seventh aspect of the present invention, in the imaging mass spectrometry according to any one of the first to third aspects, it is preferable that when at least one of the plurality of different fragment ions generated from the same precursor ion is not detected at a position on an image corresponding to each of the plurality of positions, the display unit displays a molecule corresponding to the precursor ion at the position as not detected.

According to an eighth aspect of the present invention, a mass spectrometric method by mass spectrometry imaging, comprises: ionizing a sample at a plurality of positions on the sample; performing mass spectrometry on the ionized sample and detecting fragment ions generated by dissociation of a precursor ion derived from the sample; acquiring intensity data in which intensities of a fragment ion are correlated with a plurality of positions on the sample; generating image data in which a value obtained by integrating the intensity data corresponding to a plurality of different fragment ions generated from the same precursor ion is expressed by a pixel value or a pixel color at positions on an image respectively corresponding to the plurality of positions; and displaying an image based on the image data.

According to a ninth aspect of the present invention, in a computer-readable computer program product, comprises a program that causes a processor to preform: a data acquisition process of acquiring intensity data in which intensities of a fragment ion generated by dissociation of a precursor ion derived from the sample are correlated with a plurality of positions on a sample; and a display control process of causing a display device to display a value obtained by integrating the intensity data corresponding to a plurality of different fragment ions generated from the same precursor ion as a pixel value or a pixel color at positions on an image respectively corresponding to the plurality of positions.

### Advantageous Effects of Invention

According to the present invention, a distribution of a molecule corresponding to a plurality of detected fragment ions can be clearly visualized even when the intensity of each fragment is low.

### BRIEF DESCRIPTION OF DRAWINGS

FIG. 1 is a conceptual view showing a configuration of an imaging mass spectrometry device according to one embodiment.

FIG. 2A is a conceptual view showing a target region of a sample, FIG. 2B is a conceptual view showing an intensity image of a fragment ion A, and FIG. 2C is a conceptual view showing an intensity image of a fragment ion B.

FIG. 3 is a conceptual view showing an intensity image, without distinction between an intensity of the fragment ion A and an intensity of the fragment ion B.

FIG. 4 is a conceptual view showing an example of a display screen of the imaging mass spectrometry device.

FIG. 5 is a conceptual view showing an example of a screen component in the display screen of the imaging mass spectrometry device.

FIG. 6 is a conceptual view showing an example of the display screen of the imaging mass spectrometry device.

FIG. 7 is a conceptual view showing an example of the display screen of the imaging mass spectrometry device.

FIG. 8 is a flowchart showing a flow of a mass spectrometric method according to one embodiment.

FIG. 9 is a conceptual view showing an intensity image, without distinction between an intensity of the fragment ion A and an intensity of the fragment ion B.

FIG. 10 is a conceptual view for explaining program.

### DESCRIPTION OF EMBODIMENTS

An embodiment of the present invention will be described hereinafter with reference to the drawings. In the following embodiment, a mass spectrometry device (imaging mass spectrometry device) that can be used for mass spectrometric imaging will be described.

### First Embodiment

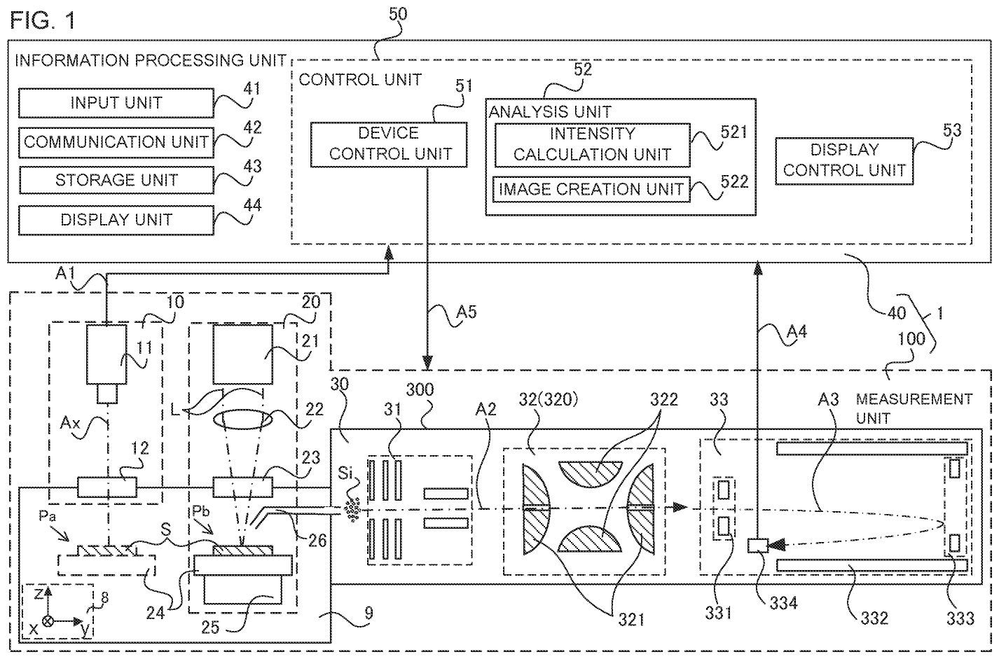

FIG. 1 is a conceptual view for explaining an imaging mass spectrometry device according to the present embodiment. The imaging mass spectrometry device 1 includes a measurement unit 100 and an information processing unit 40. The measurement unit 100 includes a sample chamber 9, a sample image capturing unit 10, an ionization unit 20, and a mass spectrometry unit 30.

The sample image capturing unit 10 includes an image-capturing unit 11 and an observation window 12. The ionization unit 20 includes a laser irradiation unit 21, a condensing optical system 22, an irradiation window 23, a sample stage 24 on which a sample S is to be placed, a sample stage drive unit 25, and an ion transport tube 26. The mass spectrometry unit 30 includes a vacuum chamber 300, an ion transport optical system 31, a first mass separation unit 32, and a second mass separation unit 33. The first mass separation unit 32 includes an ion trap 320. The ion trap 320 includes an endcap electrode 321 and a ring electrode 322. The second mass separation unit 33 includes an acceleration electrode 331, a flight tube 332, a reflectron electrode 333, and a detection unit 334.

The information processing unit 40 includes an input unit 41, a communication unit 42, a storage unit 43, a display unit 44, and a control unit 50. The control unit 50 includes a device control unit 51, an analysis unit 52, and a display control unit 53. The analysis unit 52 includes an intensity calculation unit 521 and an image creation unit 522.

The measurement unit 100 performs measurement of a sample S by mass spectrometry imaging.

The sample chamber 9 is a chamber in which substantially atmospheric pressure is maintained. In the sample chamber 9, a sample stage 24 and a sample stage drive unit 25 provided with a motor, a speed reduction mechanism, and the like are disposed. The sample stage 24 is driven by the sample stage drive unit 25 so that the sample stage 24 can move between an image-capturing position Pa at which the image-capturing unit 11 can capture an image of the sample S, and an ionization position Pb at which the laser irradiation unit 21 can irradiate the sample S with a laser beam L. The sample chamber 9 is provided with the observation window 12 and the irradiation window 23. A surface of the sample stage 24 on which the sample S is to be placed is arranged in the xy plane, and an optical axis Ax of the sample image capturing unit 10 is defined along the z-axis (see a coordinate axes 8). The y-axis is parallel to an ion optical axis A2 (described later) of the mass spectrometry unit 30, and the x-axis is perpendicular to the y-axis and the z-axis.

The sample image capturing unit 10 captures an image of the sample S (hereinafter, referred to as a sample image). The sample image capturing unit 10 outputs a signal obtained through photoelectric conversion of light from the sample S, to the control unit 50 (an arrow A1).

The sample image is not particularly limited as long as it is an image showing a plurality of positions in a portion to be analyzed in the sample S and the corresponding intensity or wavelength of light from the positions. For example, the sample image is an image of light transmitted through the sample S irradiated with light from a transmission illumination unit (not shown), captured by the image-capturing unit 11. In capturing a sample image, a specific structure or molecule of the sample S may be stained with a staining reagent or labeled with a fluorescent substance introduced by antibody reaction or genetic recombination, for example. The image-capturing unit 11 can then output a signal obtained by photoelectric conversion of light from the stained portion or from the fluorescent substance or the like, to the control unit 50.

The image-capturing unit 11 includes an image sensor such as a CCD or a CMOS. Light from the sample S placed on the sample stage 24 arranged at the observation position Pa transmits through the observation window 12 and is incident on the image-capturing unit 11. The image-capturing unit 11 photoelectrically converts the light from the sample S with a photoelectric conversion element for each pixel of the image sensor. The image-capturing unit 11 performs an A/D conversion on a signal obtained by photoelectric conversion and generates sample image data correlating each pixel corresponding to a position on a sample image with a digital signal obtained by the A/D conversion. The image-capturing unit 11 then outputs the sample image data to the control unit 50.

The ionization unit 20 irradiates a plurality of positions in a portion to be analyzed in the sample S with the laser beam L, and ionizes the sample S by matrix assisted laser desorption/ionization (MALDI). The position in the sample S irradiated with the laser beam L for ionization is referred to as an irradiation position. The ionization unit 20 sequentially irradiates each irradiation position with the laser beam L to sequentially ionize sample components in an irradiation range corresponding to each irradiation position.

The laser irradiation unit 21 includes a laser light source. The type of the laser light source is not particularly limited as long as each irradiation position in the sample S can be irradiated with the laser beam L to cause ionization of sample components. For example, the laser light source may be a device that emits, through oscillation, the laser beam L having a wavelength corresponding to the ultraviolet to infrared region.

The condensing optical system 22 includes a lens and the like to adjust an irradiation range of the laser beam L on the sample S. The laser beam L having passed through the condensing optical system 22 transmits through the irradiation window 23 and is incident on the sample S.

When the laser beam L is irradiated onto an irradiation position in the sample S, sample components in an irradiation range are desorbed and ionized to generate sample-derived ions Si. In the following, the sample-derived ions Si refer to not only ionized samples S, but also ions generated by dissociation or decomposition of the ionized samples S, ions obtained by attachment of atoms or atomic groups to the ionized samples S, and the like. The sample-derived ions Si released and generated from the sample S pass through the inside of the ion transport tube 26 and are introduced into the vacuum chamber 300 of the mass spectrometry unit 30.

The sample stage 24 at the ionization position Pb is configured to be movable in the x direction and the y direction by the sample stage drive unit 25. After an irradiation position in the sample S is irradiated with the laser beam L, the sample stage 24 moves so that the next irradiation position is irradiated with the laser beam L. In this way, the laser beam L scans over the sample S by relative movement of the sample stage 24 with respect to an optical path of the laser beam L. Thus, the term “ionization position Pb” includes a plurality of positions to which the sample stage 24 is moved for laser irradiation.

Note that the irradiation position may be changed by changing the optical path of the laser beam L, instead of moving the sample stage 24.

The mass spectrometry unit 30 performs detection through mass separation of the sample-derived ions Si. Paths of the sample-derived ions Si (an ion optical axis A2 and an ion flight path A3) in the mass spectrometry unit 30 are schematically indicated by dashed-and-dotted arrows. The sample-derived ions Si introduced into the vacuum chamber 300 enter the ion transport optical system 31.

The ion transport optical system 31 includes elements that control movement of ions, such as an electrostatic electromagnetic lens and a high-frequency ion guide, to transport the sample-derived ions Si to the first mass separation unit 32 while converging a trajectory of the sample-derived ions Si. The vacuum chamber 300 is divided into a plurality of vacuum compartments having different degrees of vacuum. Elements of the ion transport optical system 31 are respectively arranged in a plurality of vacuum compartments. A vacuum compartment located closer to the first mass separation unit 32 has a higher degree of vacuum, with the degree of vacuum increasing stepwise as appropriate. Each vacuum compartment is evacuated by a vacuum pump (not shown).

The first mass separation unit 32 includes an ion trap 320 as a mass analyzer, and performs mass separation and dissociation of the sample-derived ions Si. The first mass separation unit 32 and the second mass separation unit 33 described later are evacuated by a vacuum pump, such as a turbo molecular pump, to a degree of vacuum depending on the disposed mass analyzer.

The first mass separation unit 32 separates a sample-derived ion Si having m/z (corresponding to the mass-to-charge ratio) determined based on an input to the input unit 41, as a precursor ion. The precursor ion derived from the sample S (hereinafter simply referred to as a precursor ion) is separated by an electromagnetic action based on voltages applied to the endcap electrode 321 and the ring electrode 322 disposed in the ion trap 320.

The first mass separation unit 32 dissociates the separated and trapped precursor ion by collision induced dissociation (CID) to generate fragment ions derived from the sample S (hereinafter simply referred to as fragment ions). The first mass separation unit 32 introduces a CID gas containing an inert gas such as helium from a CID gas inlet (not shown) and causes the precursor ion and the CID gas to collide with each other with a predetermined collision energy. The first mass separation unit 32 emits the fragment ions generated by the dissociation toward the second mass separation unit 33.

The second mass separation unit 33 includes a time-of-flight mass analyzer. The second mass separation unit 33 performs mass separation of the fragment ions generated by the first mass separation unit 32, according to a difference in flight time. The fragment ions accelerated by a pulse voltage applied to the acceleration electrode 331 flies through the inside of the flight tube 332 which defines a flight path of the ion, and changes their travel direction by electromagnetic action based on a voltage applied to the reflectron electrode 333. Thereafter, the fragment ions enter the detection unit 334.

The detection unit 334 includes an ion detector such as a microchannel plate to detect the fragment ions having entered thereto. The detection mode may be either a positive ion mode for detecting positive ions or a negative ion mode for detecting negative ions. A detection signal obtained by detecting the fragment ion is A/D-converted into a digital signal and input to the information processing unit 40 (an arrow A4) and then stored in the storage unit 43 as measurement data.

The information processing unit 40 includes an information processing apparatus such as an electronic computer, so that the information processing unit 40 serves as an interface with a user of the imaging mass spectrometer 1 (hereinafter simply referred to as a “user”) as appropriate and further performs processing such as communication, storage, and computation of various data. The information processing unit 40 serves as an information processing apparatus that performs processing, such as control of the measurement unit 100, analysis, and display.

Note that the information processing unit 40 may be integrated with the measurement unit 100 into one single device. Further, a part of data used by the imaging mass spectrometry device 1 may be stored in a remote server or the like, and a part of the arithmetic processing to be performed by the imaging mass spectrometry device 1 may be performed by the remote server or the like. The control of the operation of each component of the measurement unit 100 may be performed by the information processing unit 40 or may be performed by a device constituting each component.

The input unit 41 of the information processing unit 40 includes an input device such as a mouse, a keyboard, various types of buttons, and/or a touch panel. The input unit 41 receives information required for measurement performed by the measurement unit 100 and processing performed by the control unit 50, for example, from the user.

The communication unit 42 of the information processing unit 40 includes a communication device that can communicate via a network such as the Internet with wireless or wired connection. The communication unit 42 transmits and receives necessary data as appropriate. For example, the communication unit 42 receives data necessary for the measurement of the measurement unit 100 and transmits data processed by the control unit 50.

The storage unit 43 of the information processing unit 40 includes a non-volatile storage medium. The storage unit 43 stores fragment ion intensity ratio data (described later), measurement data based on a detection signal output from the detection unit 334 (hereinafter simply referred to as measurement data), and a program for executing processing by the control unit 50, and the like.

The display unit 44 of the information processing unit 40 includes a display device such as a liquid crystal monitor. The display unit 44 is controlled by the display control unit 53 to display information on analysis conditions of the measurement by the measurement unit 100, data obtained by the analysis by the analysis unit 52, and the like, on the display device.

The control unit 50 of the information processing unit 40 includes a processor such as a CPU. The control unit 50 performs various types of processing by executing programs stored in the storage unit 43 or the like, such as control of the measurement unit 100, analysis of measurement data, and display of data obtained by the analysis.

The device control unit 51 controls the operation of each component of the measurement unit 100. The device control unit 51 controls irradiation of the sample S with the laser beam L and controls mass separation, dissociation, detection, and the like, based on analysis conditions set by the input from the input unit 41 and the like.

The analysis unit 52 performs analysis of measurement data, including creation of an intensity image (described later).

The intensity calculation unit 521 of the analysis unit 52 correlates m/z of a detected fragment ion with the detected intensity from the measurement data to calculate the intensity corresponding to the fragment ion.

The intensity calculation unit 521 converts a flight time into m/z using calibration data acquired in advance, and creates data corresponding to a mass spectrum in which m/z and the detected ion intensity are correlated with each other (hereinafter referred to as mass spectrum data). After performing processing for reducing noise such as background removal, the intensity calculation unit 521 calculates a peak intensity or a peak area of a peak in a mass spectrum as a value indicating the intensity of the fragment ion corresponding to the peak. Furthermore, the intensity calculation unit 521 identifies peaks of the mass spectrum corresponding to the same fragment ion at respective irradiation positions, based on the mass separation accuracy of the mass spectrometry unit 30.

The intensity calculation unit 521 causes the storage unit 43 to store intensity data in which an irradiation position and the intensity of a fragment ion obtained by irradiating the irradiation position with the laser beam L are correlated with each other, for each fragment ion. For example, assuming that there are a total of 10,000 irradiation positions (100 vertical positions×100 horizontal positions) arranged in a square lattice, 100 positions arranged in the horizontal direction may correspond to rows of the matrix and 100 positions arranged in the vertical direction may correspond to columns of the matrix. In this case, the intensity calculation unit 521 can generate and acquire, as intensity data, two-dimensional array data corresponding to the 100×100 matrix having the calculated intensity of the fragment ion as elements, and can store the data in the storage unit 43.

Note that the way of expression of the intensity data is not particularly limited as long as the analysis unit 52 can analyze the intensity data.

The image creation unit 522 of the analysis unit 52 creates data corresponding to the intensity image (hereinafter referred to as intensity image data) based on the intensity data. The intensity image is an image showing a plurality of pixels respectively corresponding to a plurality of positions of the sample S, correlated with intensity of the fragment ion corresponding to a predetermined m/z. The image creation unit 522 assigns each irradiation position to one pixel and converts the intensity of the fragment ion corresponding to each irradiation position into a pixel value to create intensity image data, and then stores the data in the storage unit 43.

The image creation unit 522 creates data (hereinafter referred to as individual intensity image data) corresponding to intensity image (hereinafter referred to as individual intensity image) showing the intensity of each fragment ion dissociated from the precursor ion, and also creates data (hereinafter referred to as integrated intensity image data) corresponding to intensity image (hereinafter referred to as an integrated intensity image) showing the intensities corresponding to the plurality of fragment ions dissociated from the precursor ion without distinction between different fragment ions.

Creation of Individual Intensity Image Data

The image creation unit 522 acquires intensity data on each fragment ion stored in the storage unit 43 and converts the intensity of the fragment ion at each irradiation position in the intensity data into a pixel value to create individual intensity image data. The image creation unit 522 creates individual intensity image data so that the intensities of the fragment ion are displayed in a distinguished manner in the individual intensity image. The image creation unit 522 preferably allows the intensities to be displayed in a distinguished manner in the individual intensity image, by changing any one of hue, saturation, and brightness in accordance with the intensity of the fragment ion.

The way of calculation of a pixel value of the individual intensity image from the intensity by the image creation unit 522 is not particularly limited; however, the image creation unit 522 can perform the calculation as follows, for example. The image creation unit 522 can compare intensities at all irradiation positions for each fragment ion to acquire the maximum intensity and the minimum intensity, and then convert the intensity at each irradiation position into a pixel value based on at least one of the maximum intensity and the minimum intensity. As a more specific example, assuming that the maximum intensity is 10000 (A.U.) and the minimum intensity is 100 (A.U.) for all irradiation positions and the intensity is converted into a pixel value of the same color such as red (R) in 256 levels, it is possible to set the intensity value 10000 (A.U.) to the pixel value 255 and the intensity value 100 (A.U.) to 0. An intensity value between the maximum intensity value and the minimum intensity value can be converted so that a change in intensity value and a change in pixel value have a predetermined relationship such as first order.

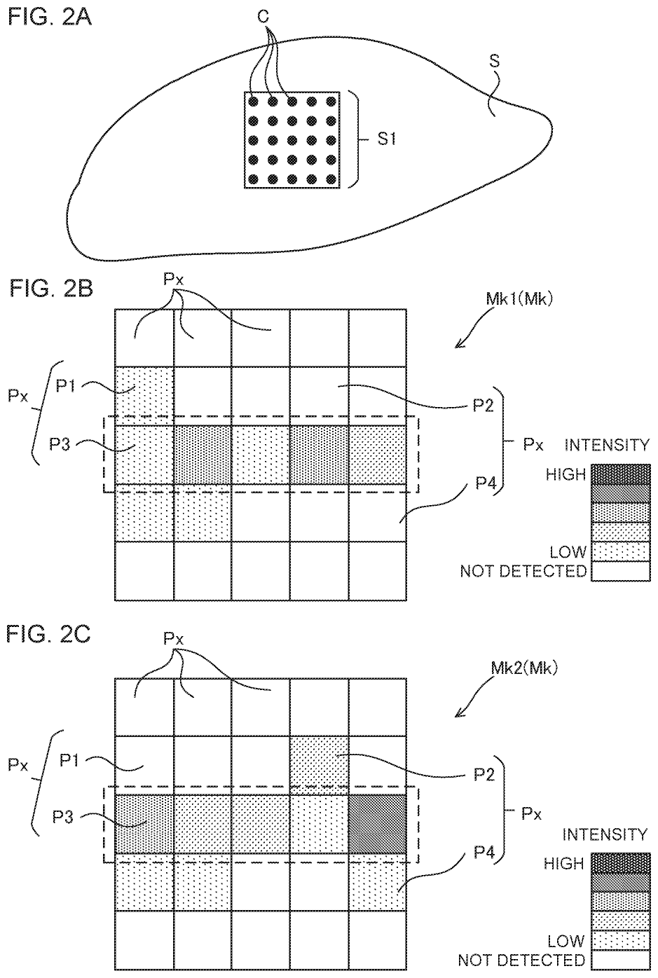

FIG. 2A is a conceptual view showing a portion to be analyzed in the sample S (hereinafter referred to as a target region S1). Here, the sample S is assumed to be a tissue section or the like taken from an organism; however, the type of the sample S is not particularly limited thereto. In the following example, the imaging mass spectrometry device 1 irradiates the laser beam L on a total of 25 irradiation positions C (5 vertical positions×5 horizontal positions) arranged at lattice points of a square lattice in the target region S1 in the sample S, so that the mass spectrum of the fragment ion at each irradiation position C is acquired.

FIG. 2B and FIG. 2C are conceptual views for the target region S1, respectively showing the individual intensity images Mk1, Mk2 of the fragment ion A and the fragment ion B, which are fragment ions having two different m/z generated from the same precursor ion. Each of the total of 25 pixels Px (5 vertical pixels×5 horizontal pixels) corresponds to each irradiation position C of the target region S1. In FIG. 2B and FIG. 2C, the higher the intensity of the fragment ion corresponding to each pixel Px, the darker the hatching is shown (the same applies to the following intensity image). A pixel that is not hatched among the pixels Px indicates that the detected intensity of the fragment ion A or B is less than a detection threshold based on the measurement accuracy and the like, when an irradiation position C corresponding to the pixel Px is irradiated with the laser beam L for mass spectrometry (the same applies the following intensity image).

Although the examples of FIG. 2B and FIG. 2C show distributions of the fragment ions A and B generated from the same precursor ion, different intensity distributions are provided. For example, in the mass spectrometry at the irradiation position corresponding to a first pixel P1, the fragment ion A is detected while the fragment ion B is not detected. In the mass spectrometry at the irradiation positions corresponding to a second pixel P2 and a fourth pixel P4, the fragment ion B is detected while the fragment ion A is not detected. In the mass spectrometry at an irradiation position corresponding to a third pixel P3, the fragment ions A and B are both detected, but the intensities are different.

In tandem mass spectrometry, such a mismatch in the distribution of fragment ions is therefore likely to occur because the detected intensity is lower than that in a case where dissociation is not performed. Thus, even when the user or the like views these individual intensity images Mk, it is difficult for the user to recognize the tendency of the distribution of the molecule corresponding to the precursor ion, which would be a problem.

Creation of Integrated Intensity Image

The image creation unit 522 creates integrated intensity image data corresponding to an integrated intensity image showing the intensities corresponding to the plurality of fragment ions generated from the same precursor ion without distinction between different fragment ions. The image creation unit 522 calculates a pixel value corresponding to each irradiation position C in the integrated intensity image data, based on intensities of a plurality of fragment ions generated from the same precursor ion and based on a correction parameter.

The image creation unit 522 acquires a plurality of intensity data on a plurality of fragment ions generated from the same precursor ion, stored in the storage unit 43. The image creation unit 522 calculates an integrated intensity corresponding to each irradiation position C from the intensities of the plurality of fragment ions corresponding to each irradiation position C (corresponding to each pixel) in the plurality of intensity data, as well as from the correction parameter. A pixel value is then calculated from the integrated intensity.

The correction parameter is a parameter for correction based on the difference in detection efficiency depending on fragment ions. The following description will be made using an example in which the correction parameter is a scalar having a value of 0 to 1. An expression form of the correction parameter and an algorithm of performing correction using the correction parameter are not particularly limited as long as the correction parameter changes the contributions of individual fragment ions when a pixel value of integrated intensity image data is calculated from a plurality of fragment ions.

A value of the correction parameter is set based on an input from the input unit 41 or the like. When the set correction parameter is 0, the image creation unit 522 calculates an integrated intensity corresponding to each pixel as the sum of the intensities of a plurality of fragment ions. When the correction parameter is not 0, the image creation unit 522 calculates an integrated intensity corresponding to each pixel using fragment ion intensity ratio data stored in the storage unit 43.

The fragment ion intensity ratio data contains a ratio of intensities of a plurality of fragment ions derived from the same precursor ion, which is set in advance based on data obtained in the past measurement. The fragment ion intensity ratio data represents a statistical value or a predicted value of the ratio of fragment ion intensities detected when the precursor ion is dissociated and subjected to a tandem mass spectrometry under predetermined analysis conditions in which collision energy and the like are defined. Therefore, an intensity image reflecting a detection efficiency of each fragment ion can be obtained by calculating a pixel value corresponding to each pixel of the integrated intensity image based on the fragment ion intensity ratio data.

When the correction parameter is 1, the image creation unit 522 calculates an integrated intensity corresponding to each pixel of the integrated intensity image based on the amount of precursor ions corresponding to the detected amount of fragment ions, calculated from the fragment ion intensity ratio data. For example, it is assumed that a ratio of the fragment ions A and B is 2:3 in the fragment ion intensity ratio data. In this case, assuming that the fragment ions A and B are detected with the same intensity, the amount of precursor ions predicted with reference to the fragment ion A is 1.5 times higher than the amount of precursor ions predicted with reference to the fragment ion B. When the image creation unit 522 creates integrated intensity image data for the fragment ions A and B, the image creation unit 522 calculates an integrated intensity by multiplying intensities of the fragment ions A and B of the intensity data by an inverse of the ratio of the intensities of fragment ions A and B shown in the fragment ion intensity ratio data as a weighting factor.

When the correction parameter has a value between 0 and 1, the image creation unit 522 can change the value of the weighting factor continuously or stepwise between the inverse described above and 1 to calculate the integrated intensity.

The image creation unit 522 calculates the integrated intensity for each pixel in the above explained manner, and converts the integrated intensity into a pixel value in a predetermined range (for example, into a luminance value of red color in any of 256 levels) as in the case of the above-described individual intensity image creation.

Note that the way of conversion of the integrated intensity into the pixel value is not particularly limited. The image creation unit 522 can display the integrated intensity corresponding to a plurality of different fragment ions generated from the same precursor ion with a color wherein at least one of hue, saturation, and brightness of the colors is the same.

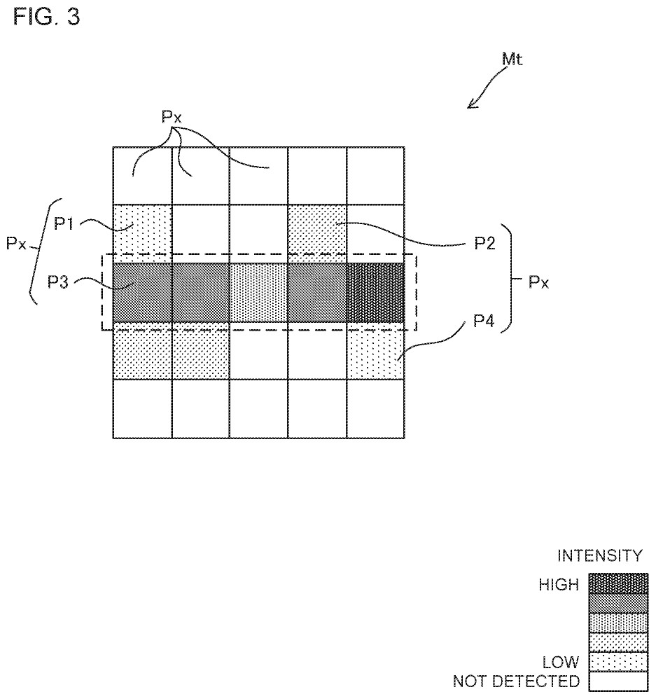

FIG. 3 is a conceptual view showing an integrated intensity image Mt for the fragment ions A and B. In the integrated intensity image Mt, a portion corresponding to the third pixel P3 in which both fragment ions A and B have been detected is shown more emphasized among the pixels Px. Thus, an overall tendency of a distribution of a molecule to be analyzed corresponding to the precursor ion (hereinafter referred to as a target molecule) is easily recognized. Furthermore, in the integrated intensity image Mt, it is also shown that fragment ions have been detected for the first pixel P1, the second pixel P2, and the fourth pixel in which one of the fragment ions A and B was detected. Thus, information on the details is relatively maintained.

The display control unit 53 creates a display image including the integrated intensity image Mt, the individual intensity image Mk, the sample image, and information, such as, on measurement conditions of the measurement unit 100 or on analysis result of the analysis unit 52 such as mass spectrum. The display control unit 53 then displays the display image on the display unit 44.

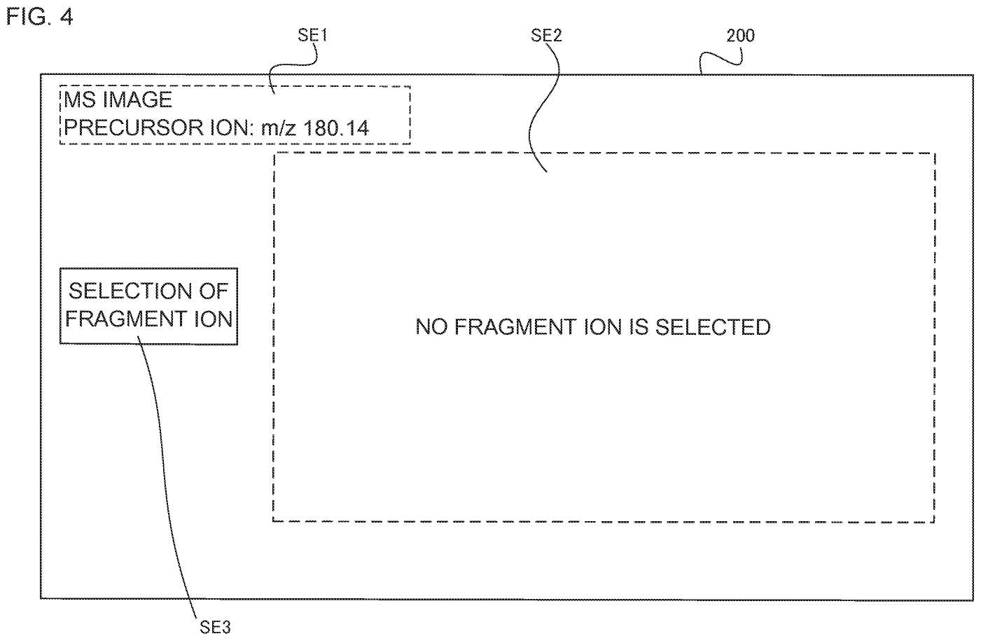

FIG. 4 is a conceptual view showing an example of an image displayed on a display screen 200 of the display unit 44 under the control of the display control unit 53. FIGS. 4 to 7 show examples of screens displayed by an analysis program for displaying an intensity image obtained by mass spectrometric imaging, the program being stored in the storage unit 43.

Note that the display screens in FIGS. 4 to 7 are examples, and the position or design of the screen components, the aspect of screen transition, and the like do not limit the present invention.

In the display screen 200 of FIG. 4, a screen component SE1 is a panel that displays a precursor ion. In the screen component SE1, a value of m/z of the precursor ion corresponding to a target molecule is displayed in characters or texts, along with the characters “MS IMAGE” that means the intensity image.

A screen component SE2 is a panel that displays an intensity image. In FIG. 4, since any fragment ion is not yet selected, no intensity image is displayed on the screen component SE2 and the characters “NO FRAGMENT ION SELECTED” are displayed for indication to the user.

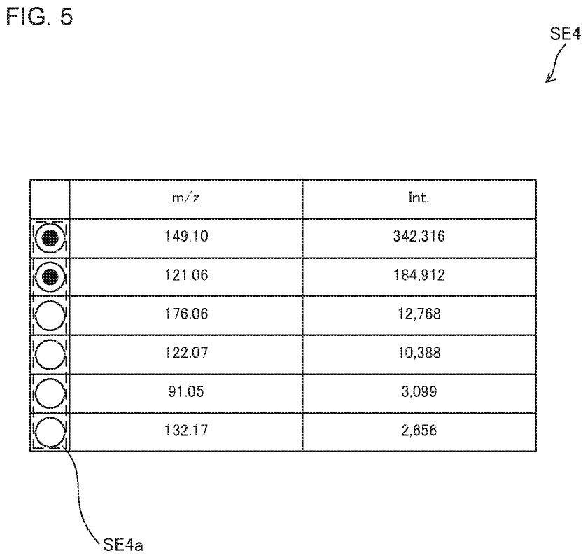

screen component SE3 is a button for selecting a fragment ion. When the user operates a cursor with a mouse or the like and clicks on the screen component SE3, the display screen displays a list of fragment ions generated from a precursor ion (a displayed precursor ion having m/z of 180.14) (FIG. 5).

FIG. 5 is a conceptual view showing a screen component SE4 showing the list of fragment ions to be displayed on the display screen 200. In the screen component SE4, m/z of fragment ions and intensity (Int.) of the fragment ions calculated by the intensity calculation unit 521, which are correlated with each other, are displayed. The intensity here may be an intensity for any pixel or may be an arithmetic average for all pixels. A screen component SE4a is displayed in the leftmost column of the list. The screen component SE4a includes a plurality of radio buttons respectively corresponding to a plurality of fragment ions. The user can click the radio buttons to switch selection/unselection of 0 or 1 or more fragment ion.

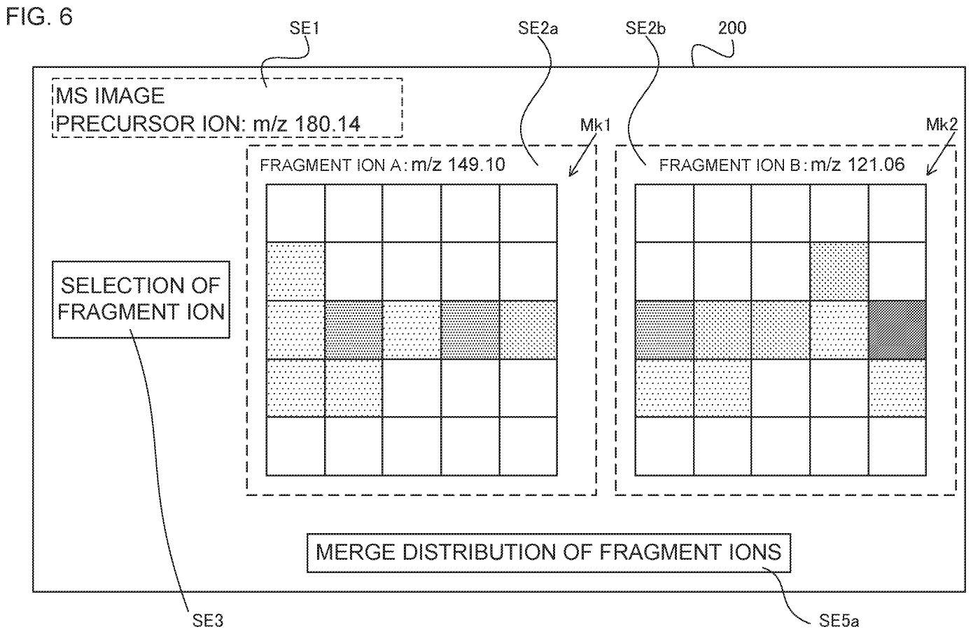

For example, as in the example of FIG. 5, the user may select a predetermined number (two in FIG. 5) of fragment ions having higher intensities. It is preferable to observe the distribution of fragment ions having higher intensities, since a distribution of the target molecule having a higher quantitativity can be determined. As another example, a characteristic peak in the precursor ion of current interest may be selected for comparison with other precursor ions. The way of selection of fragment ions is not particularly limited. When a fragment ion is selected, a confirmation button (not shown) displayed on the display screen 200 can be clicked to transition to the screen of FIG. 6.

Note that the fragment ion may be selected by clicking on the corresponding peak in the mass spectrum displayed on the display screen 200.

FIG. 6 is a conceptual view showing an example of the individual intensity images Mk1 and Mk2 displayed on the display screen 200 under the control of the display control unit 53. The screen component SE1 and the screen component SE3 are the same as those described above, and thus the description thereof is omitted.

A screen component SE2a and a screen component SE2b are panels that display the individual intensity image Mk1 for the fragment ion A and the individual intensity image Mk2 for the fragment ion B, respectively. In the screen component SE2a, the individual intensity image Mk1 is displayed below the value of m/z of the fragment ion A indicated in characters. In the screen component SE2b, the individual intensity image Mk2 is displayed below the value of m/z of the fragment ion B indicated in characters.

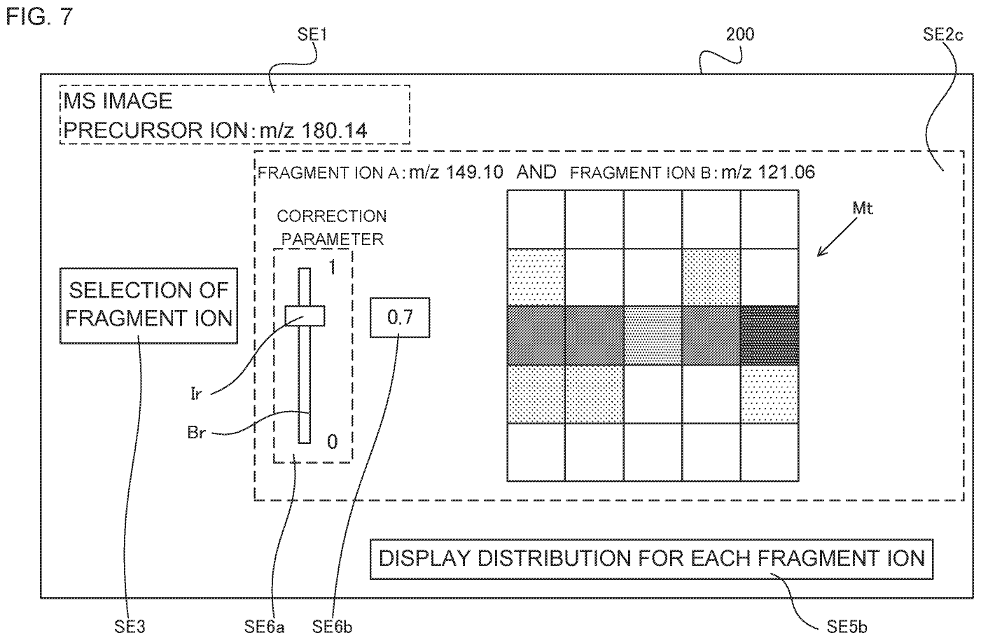

A screen component SE5a is a button for switching from a screen that displays intensities corresponding to the fragment ions A and B separately, to a screen that displays the intensities without distinguishing between the fragment ions. The user can operate a mouse or the like to click on the screen component SE5a so as to transition to a screen (FIG. 7) that displays the integrated intensity image Mt.

Note that the screen component SE5a is not limited to a button, but may be any image part such as an icon. Further, the screen that displays the individual intensity image Mk is preferably switched to the screen that displays the integrated intensity image Mt with one click as in this example; however, it is not particularly limited. For example, when the screen component SE5a is clicked, the screen component SE4 (FIG. 5) may be displayed again and then fragment ions may be selected for creating the integrated intensity image Mt.

FIG. 7 is a conceptual view showing an example of the integrated intensity image Mk displayed on the display screen 200 under the control of the display control unit 53. The screen component SE1 and the screen component SE3 are the same as those described above and thus the description thereof is omitted.

A screen component SE2c is a panel that displays an integrated intensity image Mt for the fragment ions A and B. In the screen component SE2c, the integrated intensity image Mk is displayed below the value of each m/z of the fragment ions A and B indicated in characters.

A screen component SE5b is a button for switching from a screen that displays intensities corresponding to the fragment ions A and B without distinguishing between the fragment ions, to a screen that displays the intensities separately. The user can operate a mouse or the like to click on the screen component SE5b so as to transition to a screen (FIG. 6) that displays the individual intensity images Mk.

A screen component SE6a is a slider for changing a correction parameter. The user can change a value of the correction parameter by operating the mouse to drag an indicator Ir and move it over a bar Br. When the value of the correction parameter changes, the image creation unit 522 creates the integrated intensity image Mt once again based on the value of the changed correction parameter in real time, as appropriate. The display control unit 53 displays the integrated intensity image Mt which is created once again in real time, as appropriate.

A screen component SE6b is a text box for changing the correction parameter. After clicking on the screen component SE6b, the user can input a numerical value with a keyboard and press a confirmation button or the like to change the value of the correction parameter. When the value of the correction parameter changes, the integrated intensity image Mt is created once again based on the value of the changed correction parameter, as in the case of the screen component SE6a, and displayed.

In creating the integrated intensity image data, it can be selected as desired as to which fragment ion intensity should contribute to the integrated intensity and to which degree the fragment ion intensity should contribute thereto. Therefore, by using the screen components SE6a, SE6b to easily change the correction parameter, a clearer ion distribution for the target molecule can be obtained with an appropriate correction parameter.

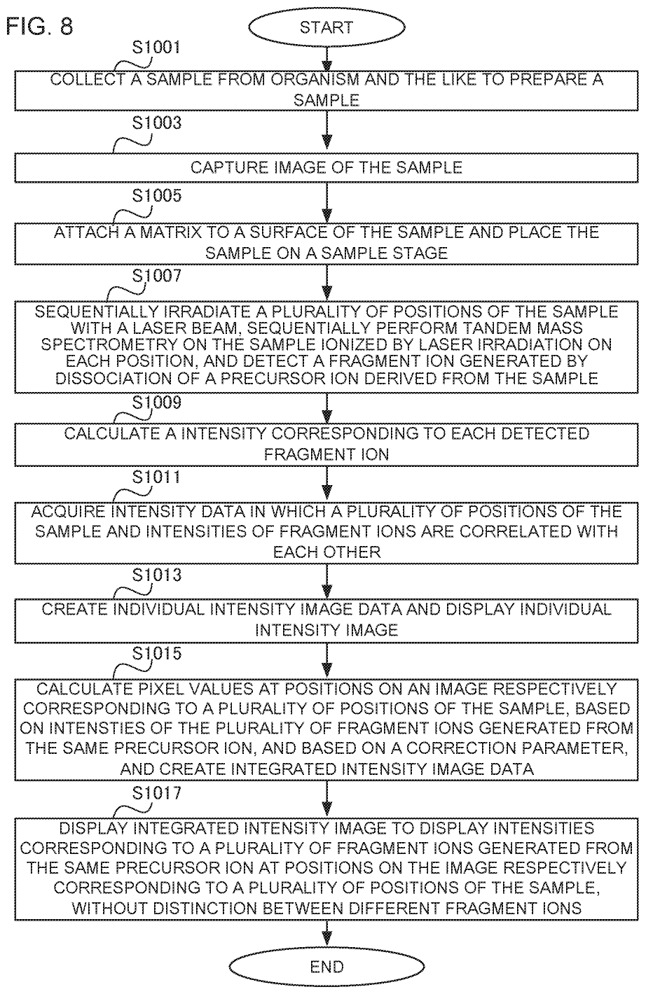

FIG. 8 is a flowchart showing a flow of a mass spectrometric method according to this embodiment. In step S1001, a user or the like takes a sample from an organism or the like to prepare a sample S. When step S1001 ends, step S1003 is started. In step S1003, the image-capturing unit 11 captures an image (sample image) of the sample S. At this time, it is preferable to attach a visualization marker to the surface of the sample S for alignment. When step S1003 ends, step S1005 is started.

In step S1005, the user or the like attaches a matrix for MALDI to the surface of the sample S by dispensing, spraying, or the like, and the sample S is placed on the sample stage 24. The type of the matrix is not particularly limited. Sinapinic acid, α-CHCA, 2,5-DHB, and the like can be used for the matrix as appropriate. When alignment is performed, an image is again captured at the image-capturing position Pa so as to include a marker for visualizing the sample S to which the matrix is attached. The sample S is then moved to the ionization position Pb by the sample stage drive unit 25, with the sample S fixed to the sample stage 24. This movement is performed so that the sample S is placed at a position where an irradiation position in the sample image designated by the user can be irradiated with the laser beam L by using the marker to correlate the sample image with the image of the sample S to which the matrix is attached. When step S1005 ends, step S1007 is started. In step S1007, the measurement unit 100 sequentially irradiates a plurality of positions (irradiation positions C) of the sample S with the laser beam L and sequentially performs tandem mass spectrometry for the sample S ionized by the laser irradiation at each position to detect fragment ions which are generated as a result of dissociation of the precursor ion derived from the sample S. When step S1007 ends, step S1009 is started.

In step S1009, the intensity calculation unit 521 calculates intensities corresponding to the detected fragment ions. When step S1009 ends, step S1011 is started. In step S1011, the analysis unit 52 acquires intensity data in which a plurality of positions of the sample S are associated with the intensities of the fragment ion. When step S1011 ends, step S1013 is started.

In step S1013, the image creation unit 522 creates individual intensity image data, and the display unit 44 displays the individual intensity image Mk. When step S1013 ends, step S1015 is started. In step S1015, the image creation unit 522 calculates pixel values at positions on an image corresponding to the plurality of positions in the sample S based on the intensities of the plurality of fragment ions generated from the same precursor ion and based on the correction parameter, to create integrated intensity image data. When step S1015 ends, step S1017 is started.

In step S1017, the display unit 44 displays the integrated intensity image Mt so as to display intensities corresponding to a plurality of fragment ions generated from the same precursor ion at positions on the image corresponding to a plurality of positions in the sample S, without distinguishing between different fragment ions. When step S1017 ends, the process ends.

According to the above-described embodiment, the following advantages effects can be achieved.

(1) In the imaging mass spectrometry device 1 of the present embodiment, the analysis unit 52 acquires intensity data in which a plurality of positions on the sample S is correlated with intensities of a fragment ions generated by dissociation of a precursor ion derived from the sample S. The image creation unit 522 generates integrated intensity image data in which a value obtained by integrating intensities corresponding to a plurality of different fragment ions generated from the same precursor ion is expressed by a pixel value or a pixel color at positions on the image corresponding to the plurality of positions on the sample S. The display unit 44 displays an integrated intensity image Mt based on the integrated intensity image data. This achieves a clear visualization of a distribution of the molecule corresponding to a plurality of detected fragment ions in a mass spectrometric imaging in which tandem mass spectrometry or multi-step mass spectrometry is performed. Specifically, it is possible to compensate for reduction in detection sensitivity in MS/MS and reduction in signal intensity in the obtained intensity distribution while maintaining the specificity of the ions detected by MS/MS.

(2) In the imaging mass spectrometry device 1 of the present embodiment, the image creation unit 522 generates integrated intensity image data in which intensities corresponding to a plurality of different fragment ions generated from the same precursor ion are displayed with colors wherein at least one of hue, saturation, and brightness of the colors are the same. The display unit 44 can display a screen based on the created image data. A distribution of a molecule corresponding to a plurality of detected different fragment ions can be further clearly visualized using color perception.

(3) In the imaging mass spectrometry device 1 of the present embodiment, the display unit 44 displays the screen component SE5a for switching from a screen that displays intensities corresponding to a plurality of different fragment ions generated from the same precursor ion separately between the fragment ions, to a screen that displays the integrated intensity image Mt. Thereby, the individual intensity image Mk and the integrated intensity image Mt can be easily switched so that information on the distribution of the target molecule can be provided more quickly.

(4) In the imaging mass spectrometry device 1 of the present embodiment, the image creation unit 522 calculates pixel values at positions on an image corresponding to the plurality of positions on the sample S based on the intensity data of the plurality of different fragment ions generated from the same precursor ion and based on the correction parameter, to create integrated intensity image data. This allows an adjustment of the contribution of fragment ions to the integrated intensity image Mt to be displayed, so that a clearer distribution of the target molecules can be provided.

(5) In the imaging mass spectrometry device 1 of the present embodiment, the display unit 44 displays the screen components SE6a and SE6b for changing the correction parameter. This allows an easy adjustment of the contribution of fragment ions to the integrated intensity image Mt to be displayed, so that a clearer distribution of the target molecules can be provided.

(6) In the imaging mass spectrometry device 1 of the present embodiment, the correction parameter is determined based on a ratio of intensities of a plurality of fragment ions set in advance based on data obtained in the past measurement. This allows a more appropriate adjustment of the contribution of fragment ions to the integrated intensity image Mt based on data obtained in the past.

The following modifications are also included within the scope of the present invention and any of the modifications can be combined with the embodiment described above. In the following modifications, parts having the same structure and function as those in the above-described embodiment are denoted by the same reference numerals, and the description thereof will be omitted as appropriate.

First Modification

Although the imaging mass spectrometry device 1 of the above-described embodiment includes the ion trap and the time-of-flight mass separation unit, the configuration of the mass spectrometry unit 30 is not particularly limited as long as tandem mass spectrometry or multi-stage mass spectrometry can be performed. The mass spectrometry unit 30 may include a mass separation unit composed of two or more mass analyzers in combination different from the above-described embodiment. For example, the imaging mass spectrometry device 1 can be configured as a quadrupole time-of-flight mass spectrometer, a tandem time-of-flight mass spectrometer, or a triple quadrupole mass spectrometer. Further, the time-of-flight mass analyzer of the mass spectrometry unit 30 may be of an orthogonal acceleration type, other than a type of accelerating in a direction along a direction of entering into the time-of-flight mass analyzer as shown in FIG. 1. Moreover, the time-of-flight mass analyzer may be of a linear type or multi-turn type, other than the reflectron type shown in FIG. 1.

In a case where the imaging mass spectrometry device 1 constitutes a tandem mass spectrometer or a multi-stage mass spectrometer, the way of dissociation is not particularly limited. For example, other than the CID described above, infrared multiphoton dissociation, photoinduced dissociation, a dissociation method using a radical, and the like can be used as appropriate.

Although ionization is performed by MALDI in the above-mentioned embodiment, the way of ionization is not particularly limited as long as intensities of fragment ions to be analyzed correlated with a plurality of positions of the sample can be obtained. For example, probe electrospray ionization (PESI) may be used. Alternatively, components may be collected from each position of the sample to prepare a sample for mass spectrometry, and liquid chromatography/mass spectrometry (LC/MS) using electrospray is performed for each sample for mass spectrometry.

Second Modification

In the above-described embodiment, the image creation unit 522 calculates the sum of intensities of a plurality of fragment ions without using a correction parameter (corresponding to a case where the correction parameter is 0), or calculates a weighted sum based on the correction parameter of the intensities to calculate the integrated intensity. Furthermore, the image creation unit 522 calculates a pixel value of the integrated intensity image Mt from the calculated integrated intensity. However, the image creation unit 522 may calculate the pixel value of the integrated intensity image Mt by any operation such as arithmetic operation from pixel values of individual intensity images Mk of a plurality of fragment ions. In other words, the image creation unit 522 can calculate the pixel value of the integrated intensity image Mt directly from the pixel value of the individual intensity image Mk without calculating the integrated intensity from the intensities of the fragment ions. As a result, the amount of calculation can be reduced, and also the integrated intensity image Mt can be created even if there is no original intensity data and only pixel values from the image data are available.

Note that the image creation unit 522 may set the largest value from pixel values of the individual intensity images Mk of the plurality of fragment ions as the pixel value of the integrated intensity image Mt, for a pixel Px corresponding to each irradiation position C. As a result, addition of the intensity values increases the maximum intensity, so that a reduction in a contrast of the integrated intensity image Mt can be prevented. As described above, the way of calculation is not particularly limited and various calculations can be performed as long as pixel values of the integrated intensity image Mt can be obtained when integrating intensity data or intensities such that the contrast is further emphasized compared to a case where the intensity of each fragment ion is displayed as an individual intensity image.

Third Modification

In the image creation unit 522, if one of the fragment ions used in creating the integrated intensity image Mt is not detected for a pixel corresponding to an irradiation position C (if the detection intensity is equal to or less than the detection threshold), the integrated intensity of said pixel Px in the integrated intensity image Mt can be considered to be equal to or less than a detection threshold.

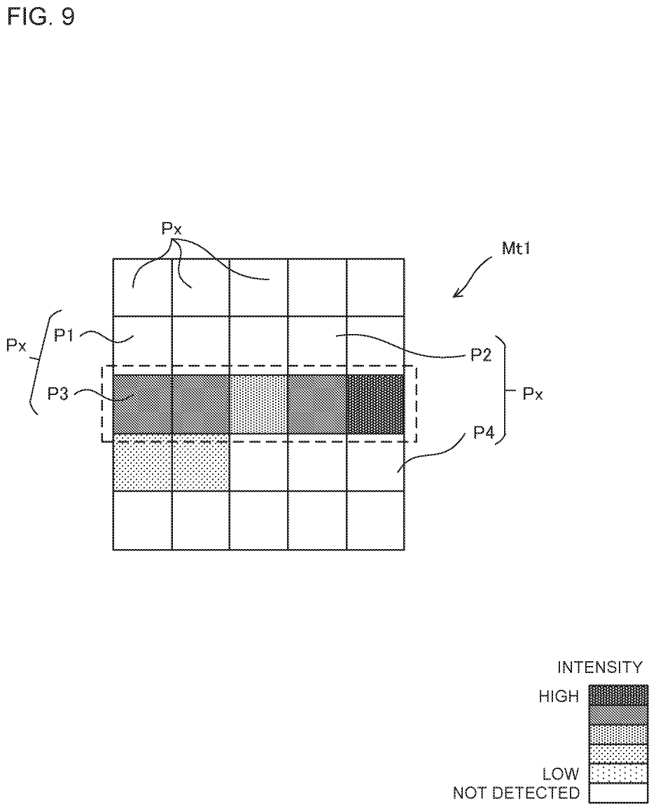

FIG. 9 is a conceptual view showing an integrated intensity image Mt1 of the present modification. The integrated intensity image Mt1 is created from intensity data (individual intensity images Mk1 and Mk2 (corresponding to FIGS. 2B and 2C)) for each of the fragment ions A and B. The first pixel P1, the second pixel P2, and the fourth pixel P4 are displayed in the integrated intensity image Mt1 such that no fragment ion has been detected, because one of the fragment ions A or B is not detected.

In the imaging mass spectrometry device of the present modification, when at least one of a plurality of fragment ions generated from the same precursor ion is not detected at a position on the image corresponding to each of the plurality of positions of the sample S, the display unit 44 displays a target molecule corresponding to the precursor ion at the position as “not detected”. This allows a reduction of noise due to an unintended detection of a molecule different from fragment ions of the target molecule.

Fourth Modification

It is assumed that a ratio of intensities of the plurality of fragment ions in the intensity data at a certain irradiation position C is different from a ratio in the fragment ion intensity ratio data stored in advance in the storage unit 43 by a predetermined percentage (such as 20% or 50%) or more. In this case, the image creation unit 522 can change the way of calculation of the corresponding pixel value in the integrated intensity image Mt, for example, by giving a higher weight to the value of intensity of fragment ion having a higher reliability, compared with a case where the ratios do not differ by a predetermined percentage or more. This can achieve a reduction of noise due to an unintended detection of a peak caused by a molecule different from fragment ions of the target molecule being mixed. This is useful when a m/z resolution in the mass spectrometry unit 30 is low.

Fifth Modification

In the above-described embodiment, the information processing unit 40 may be arranged in an information processing device such as a general-purpose personal computer incorporating the program for generating the intensity image data, so that the information processing device may be configured as an analysis device. In this case, the information processing unit 40 may not include the device control unit 51.

Sixth Modification

Programs for achieving the information processing functions of the imaging mass spectrometry device 1 may be recorded in a computer readable recording medium. Programs for measurement, analysis, and display processing and control of related processing, including the processing by the above-mentioned image creation unit 522 and display control unit 53, may be recorded in the recording medium, and read and executed by a computer system. Here, the term “computer system” includes an operating system (OS) and hardware of peripheral devices. The term “computer-readable recording medium” refers to a portable recording medium such as a flexible disk, a magneto-optical disk, an optical disk, and a memory card, and a storage device such as a hard disk incorporated in a computer system. Furthermore, the term “computer-readable recording medium” may include medium that dynamically holds a program for a short time, such as a communication line in a case where a program is transmitted via a network such as the Internet or a communication line such as a telephone line, or medium that holds a program for a certain period of time, such as a volatile memory in a computer system that becomes a server or a client in that case. Further, the above-described program may be intended to achieve a part of the above-described functions, or may be combined with a program already recorded in a computer system to achieve the above-described functions.

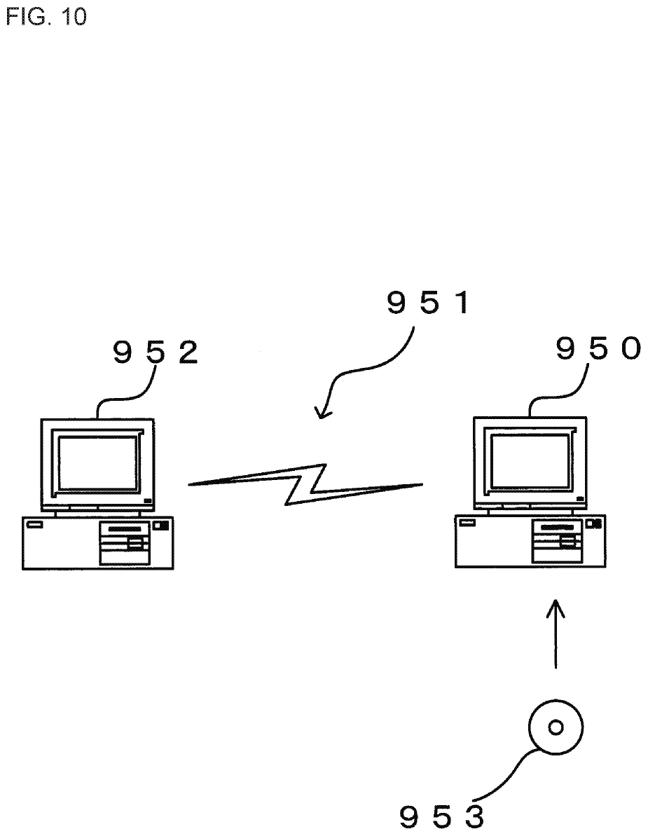

When applied to a personal computer (hereinafter referred to as a PC) or the like, the program relating to the control described above can be provided through a recording medium such as a CD-ROM or a data signal such as the Internet. FIG. 10 shows such a situation. A PC 950 receives a program via a CD-ROM 953. The PC 950 also has a connection function with a communication line 951. A computer 952 is a server computer that provides the above-described program, and stores the program in a recording medium such as a hard disk. The communication line 951 is a communication line such as the Internet or personal computer communication, or a dedicated communication line. The computer 952 reads the program using a hard disk, and transmits the program to the PC 950 via the communication line 951. That is, the program is carried by a carrier wave as a data signal and transmitted through the communication line 951. Thus, the program can be supplied as various forms of computer readable computer program products such as a recording medium and a carrier wave.

A program for achieving the above-described information processing functions includes a program that causes a processor to preform: a data acquisition process (corresponding to step S1011 in FIG. 8) of acquiring intensity data in which intensities of fragment ions generated by dissociation of a precursor ion derived from the sample S are correlated with a plurality of positions on the sample S; and a display control process (corresponding to step S1015) of causing the display device to display, as a pixel value or a pixel color at each position on an image corresponding to each of a plurality of positions on the sample S, a value obtained by integrating the intensity data corresponding to the plurality of different fragment ions generated from the same precursor ion. This achieves a clear visualization of a distribution of the molecule corresponding to a plurality of detected fragment ions, using data obtained by a mass spectrometric imaging in which tandem mass spectrometry or multi-step mass spectrometry is performed.

The present invention is not limited to the above embodiments. Other embodiments contemplated within the scope of the technical concept of the present invention are also included within the scope of the present invention.

### REFERENCE SIGNS LIST

1 . . . imaging mass spectrometry device, 10 . . . sample image capturing unit, 11 . . . image-capturing unit, 20 . . . ionization unit, 21 . . . laser irradiation unit, 22 . . . condensing optical system, 24 . . . sample stage, 25 . . . sample stage drive unit, 30 . . . mass spectrometry unit, 32 . . . first mass separation unit, 33 . . . second mass separation unit, 40 . . . information processing unit, 43 . . . storage unit, 50 . . . control unit, 51 . . . device control unit, 52 . . . analysis unit, 53 . . . display control unit, 100 . . . measurement unit, 200 . . . display screen, 300 . . . vacuum chamber, 334 . . . detection unit, 521 . . . intensity calculation unit, 522 . . . image creation unit, C . . . irradiation position, Mk, Mk1, Mk2 . . . individual intensity image, Mt, Mt1 . . . integrated intensity image, P1 . . . first pixel, P2 . . . second pixel, P3 . . . third pixel, P4 . . . fourth pixel, Px . . . pixel, S . . . sample, S1 . . . target region, SE1, SE2, SE2a, SE2b, SE2c, SE3, SE4, SE4a, SE5a, SE5b, SE6a, SE6b . . . screen component, Si . . . sample-derived ion

1. An imaging mass spectrometry device, comprising:
an ionization unit that ionizes a sample at a plurality of positions on the sample;
a mass spectrometry unit that performs mass spectrometry on the ionized sample and detects fragment ions generated by dissociation of a precursor ion derived from the sample;
a data acquisition unit that acquires intensity data in which intensities of a fragment ion are correlated with the plurality of positions on the sample;
an image creation unit that creates image data in which a value obtained by integrating the intensity data corresponding to a plurality of different fragment ions generated from the same precursor ion is expressed by a pixel value or a pixel color at positions on an image respectively corresponding to the plurality of positions; and
a display unit that displays an image corresponding to the image data.

2. The imaging mass spectrometry device according to claim 1, wherein:
the image creation unit creates the image data corresponding to the image in which the values corresponding to the same precursor ion are displayed with colors wherein at least one of hue, saturation, and brightness of the colors are the same.

3. The imaging mass spectrometry device according to claim 1, wherein:
the display unit displays a first screen component for switching to a screen that displays the image from a screen that displays intensities corresponding to the plurality of different fragment ions generated from the same precursor ion separately between the fragment ions.

4. The imaging mass spectrometry device according to claim 1, wherein:
the image creation unit calculates pixel values at positions on an image corresponding to the plurality of positions based on the intensity data of the plurality of different fragment ions generated from the same precursor ion and a correction parameter, to create the image data.

5. The imaging mass spectrometry device according to claim 4, wherein:
the display unit displays a second screen component for changing the correction parameter.

6. The imaging mass spectrometry device according to claim 4, wherein:
the correction parameter is determined based on a ratio of intensities of the plurality of fragment ions set in advance based on data obtained in a past measurement.

7. The imaging mass spectrometry according to claim 1, wherein:
when at least one of the plurality of different fragment ions generated from the same precursor ion is not detected at a position on an image corresponding to each of the plurality of positions, the display unit displays a molecule corresponding to the precursor ion at the position as not detected.

8. A mass spectrometric method by mass spectrometry imaging, comprising:
ionizing a sample at a plurality of positions on the sample;
performing mass spectrometry on the ionized sample and detecting fragment ions generated by dissociation of a precursor ion derived from the sample;
acquiring intensity data in which intensities of a fragment ion are correlated with a plurality of positions on the sample;
generating image data in which a value obtained by integrating the intensity data corresponding to a plurality of different fragment ions generated from the same precursor ion is expressed by a pixel value or a pixel color at positions on an image respectively corresponding to the plurality of positions; and
displaying an image based on the image data.

9. A computer-readable computer program product, comprising a program that causes a processor to preform:
a data acquisition process of acquiring intensity data in which intensities of a fragment ion generated by dissociation of a precursor ion derived from the sample are correlated with a plurality of positions on a sample; and
a display control process of causing a display device to display a value obtained by integrating the intensity data corresponding to a plurality of different fragment ions generated from the same precursor ion as a pixel value or a pixel color at positions on an image respectively corresponding to the plurality of positions.

10. The imaging mass spectrometry device according to claim 2, wherein:
the display unit displays a first screen component for switching to a screen that displays the image from a screen that displays intensities corresponding to the plurality of different fragment ions generated from the same precursor ion separately between the fragment ions.

11. The imaging mass spectrometry device according to claim 2, wherein:
the image creation unit calculates pixel values at positions on an image corresponding to the plurality of positions based on the intensity data of the plurality of different fragment ions generated from the same precursor ion and a correction parameter, to create the image data.

12. The imaging mass spectrometry device according to claim 3, wherein:
the image creation unit calculates pixel values at positions on an image corresponding to the plurality of positions based on the intensity data of the plurality of different fragment ions generated from the same precursor ion and a correction parameter, to create the image data.

13. The imaging mass spectrometry according to claim 2, wherein:
when at least one of the plurality of different fragment ions generated from the same precursor ion is not detected at a position on an image corresponding to each of the plurality of positions, the display unit displays a molecule corresponding to the precursor ion at the position as not detected.

14. The imaging mass spectrometry according to claim 3, wherein:
when at least one of the plurality of different fragment ions generated from the same precursor ion is not detected at a position on an image corresponding to each of the plurality of positions, the display unit displays a molecule corresponding to the precursor ion at the position as not detected.
